(19) United States
(12) Patent Application Publication
(10) Pub. No.: US 2004/0019583 A1
(43) Pub. Date: Jan. 29, 2004

(54) External standalone database management device

(75) Inventors: Jin Ki Jung, Suwon-City (KR); Ki Hwan Kim, Suwon-City (KR); Hae Dong Jeong, Youngin-City (KR); Myung Jong Choi, Seoul (KR); Dong Jun Won, Osan-City (KR)

Correspondence Address: Ladas & Parry, 26 West 61st Street, New York, NY, 10023, US

(73) Assignee: DOOSAN TMS CORPORATION

(21) Appl. No.: 10/243,516

(22) Filed: Sep. 13, 2002

(30) Foreign Application Priority Data
Jul. 25, 2002 (KR) 2002-43806

(51) Int. Cl. G06F 17/30

(52) U.S. Cl. 707/1

(57) ABSTRACT

Disclosed is an external standalone database management device. The database management device comprises a database module of an external standalone type, and an interface. The database module includes a first storage unit for semi-permanently storing a database, a second storage unit for temporarily storing the database, an execution unit for executing the database in real time, and an initialization unit for initializing the first and second storage units and the execution unit with stable setup states when the database is executed. The interface is installed in the database module to interface contents being executed in the database module with an external management system which substantially manages the database. Data, executed by the execution unit and temporarily stored in the second storage unit, is semi-permanently stored in the first storage unit even though external power supply is interrupted. Therefore, even though the power supply is interrupted when the database management device is in use, data being executed in the device is stored so that loss thereof can be minimized. Moreover, because the database management device is of the external standalone type, additionally required costs can be curtailed. Furthermore, the present database management device is ready-to-use and requires no installation and configuration of database software.

### BACKGROUND OF THE INVENTION

1. Field of the Invention

The present invention relates to database management devices, and more particularly to an external standalone database management device.

2. Description of the Related Art

It is common that a database is provided in the form of software and a database management device is installed in a computer or the like to manage the database.

The database management device is required to secure stability and have a sufficient processing speed, in turn resulting in a need for high-level hardware to be constructed in the computer where the management device is installed, thereby causing an increase in hardware costs of the computer. Moreover, hardware of the computer directly determines speeds of a microprocessor and memory of the computer. In this regard, the construction of high-level hardware in the computer necessitates the construction of other high-level components, such as a microprocessor, memory, etc., in the computer, resulting in an increase in initial costs required for the database management.

It is important to provide a service using the database and operate the computer in a proper manner using the same. It is particularly important that the database management device is constructed to rapidly recover an error occurring when the database is in use. In this connection, the database management device has recently been designed to automatically recover an error in a clustering manner. However, the clustering of the management device incurs additional costs, and further necessitates the clustering of an operating system, network, etc.

Besides, at the moment that the supply of power to the computer is interrupted when the database is in use, data being executed is subject to loss, because the database management device conventionally employs a hard disk installed in the computer as data storage means. In more detail, data being executed in a memory of the computer is lost since the computer is powered off under the condition that the data is not stored in the hard disk.

Recently, an uninterruptible power supply (UPS) has been proposed to prevent data from being lost due to the interruption of power supply. However, the UPS must be applied to all other means of the computer as well as the hard disk for storage of the database. For this reason, the use of the UPS also leads to an increase in installation costs.

### SUMMARY OF THE INVENTION

Therefore, the present invention has been made in view of the above problems, and it is an object of the present invention to provide an external standalone database management device which is capable of minimizing a data loss and curtailing installation costs.

In accordance with the present invention, the above and other objects can be accomplished by the provision of an external standalone database management device comprising: database means of an external standalone type, the database means including first storage means for semi-permanently storing a database, second storage means for temporarily storing the database, execution means for executing the database in real time, and initialization means for initializing the first and second storage means and the execution means with stable setup states when the database is executed; and interface means installed in the database means for interfacing contents being executed in the database means with an external management system, the management system substantially managing the database; whereby data, executed by the execution means and temporarily stored in the second storage means, is semi-permanently stored in the first storage means even though external power supply is interrupted.

In a feature of the present invention, even though the power supply is interrupted when the database management device is in use, data being processed in the device is stored so that loss thereof can be minimized. Furthermore, because the database management device is of the external standalone type, additionally required costs can be curtailed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically showing the construction of an external standalone database management device in accordance with a preferred embodiment of the present invention.

### DESCRIPTION OF THE PREFERRED EMBODIMENTS

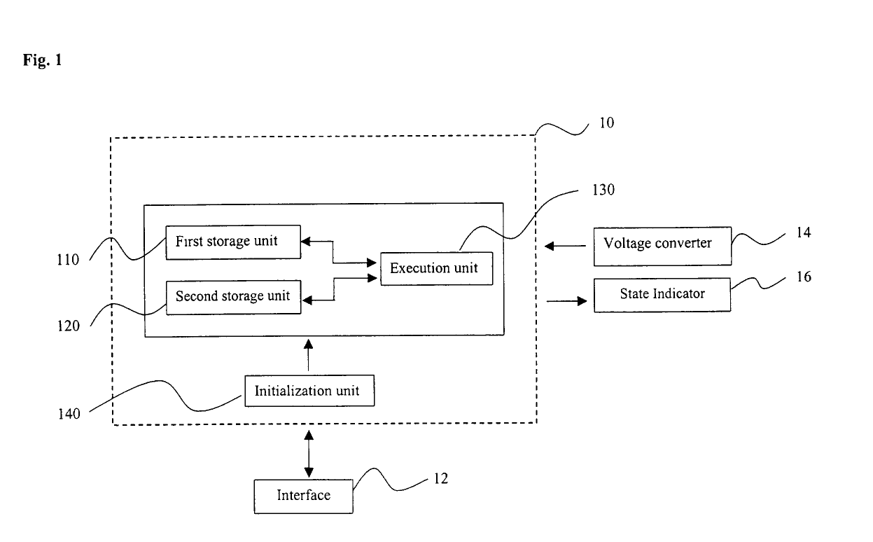

FIG. 1 is a block diagram schematically showing the construction of an external standalone database management device in accordance with a preferred embodiment of the present invention.

With reference to FIG. 1, the database management device is of an external standalone type, and comprises a database module 10 and an interface 12.

In detail, the database module 10 includes a first storage unit 110 for semi-permanently storing a database, a second storage unit 120 for temporarily storing the database, an execution unit 130 for executing the database in real time, and an initialization unit 140 for initializing the first and second storage units 110 and 120 and the execution unit 130 with stable setup states when the database is executed.

The first storage unit 110 may be, for example, any one of a flash memory, hard disk or the like. Alternatively, a combination of them may be installed and used in the database management device as the first storage unit 110. Preferably, the first storage unit 110 has an appropriate size depending on the capacity of the database, which size is determined at a user's discretion. The second storage unit 120 may be, for example, any one of a DRAM, SDRAM or the like. Alternatively, a combination of them may be installed and used in the database management device as the second storage unit 120. Preferably, the second storage unit 120 has an appropriate size depending on the capacity of the database, which size is determined at the user's discretion. The execution unit 130 may be, for example, a microprocessor. Preferably, the execution unit 130 has an appropriate size depending on the capacity of the database. The initialization unit 140 may be, for example, an IC card for storing a program for initialization of the first and second storage units 110 and 120 and the execution unit 130 with stable setup states, that is, for reconfiguration of nonlogical states of the units 110, 120 and 130 into logical states in response to the supply of power.

The interface 12 is installed in the database management device to interface contents, or data, being executed in the database module 10 with an external management system (for example, a main computer) which substantially manages the database. Namely, the interface 12 interfaces data being executed from the management device to the management system or vice versa in real time. In other words, the interface 12 receives the contents of a query from the management system, transfers the received query contents to the management device, receives the results of the query contents processed by the management device, and transfers the received results to the management system. The interface 12 may be, for example, any one of a USB port, serial port, IEEE1394 port, IR port, LAN port or etc. Alternatively, a combination of them may be installed and used in the database management device as the interface 12. It is preferred that any one of the USB port, serial port, IEEE1394 port, IR port, LAN port or etc. is used as the interface 12.

The database management device further comprises a voltage converter 14 and a state indicator 16.

In detail, the voltage converter 14 is adapted to convert the level of an external supply voltage into that of a drive voltage to the management device. For example, the voltage converter 14 converts a commercial AC voltage into a DC voltage of 5V and, in turn, the DC voltage of 5V into a constant voltage of 3.3V or 2.5V necessary to the database module 10, interface 12 and state indicator 16. The state indicator 16 is adapted to indicate operating states of the database module 10, interface 12 and voltage converter 14. The state indicator 16 may be, for example, an LED for providing a proper visual indication of an operating state of the management device to the user.

A description will hereinafter be given of the operation of the database management device with the above-stated construction in accordance with the preferred embodiment of the present invention.

First, the management device is connected to an external management system, such as a main computer, in such a manner that it can be interfaced with the management system. That is, the management device is connected to the management system in a wired or wireless manner. This connection of the management device to the management system is made by means of the interface 12.

Then, power is supplied to the management device. This power supply is made by means of the voltage converter 14. The voltage converter 14 provides a voltage of a level appropriate to the management device. Thereafter, the database module 10 is initialized with a stably operable state by the initialization unit 140. The initialization unit 140 initializes the database module 10 such that the module 10 can be stably ended when the management device completes its operation.

Under the above condition, the external management system, such as the main computer, executes an operation based on the database in the database module 10. In detail, the execution unit 130 receives and processes a query from the external management system, such as the main computer, according to an operating system program and database program stored in the first and second storage units 110 and 120. The execution unit 130 also stores the processed results in the first and second storage units 110 and 120. Note that the processed results are subject to no loss even though the supply of power is interrupted, because they are stored separately in the first storage unit 110, which is preferably a nonvolatile memory. That is, when the supply of power is interrupted, data being executed is not stored in data storage means of the management system since the data storage means is a volatile memory. However, the management device can safely store data being processed in the first storage unit 110 and complete its task utilizing internally activated battery power. Only after that, the management device proceeds for safe shutdown of itself.

The user can check operating states of the components of the management device through the state indicator 16 at any time.

As described above, the database management device is operated outside of the management system, and stores data semi-permanently. Accordingly, the management device can appropriately cope with a sudden situation change such as the interruption of power supply. Further, because the database management device is of the external standalone type, there is no need to modify the high-cost management system, such as the main computer, to meet high-level specifications.

As apparent from the above description, the present invention provides an external standalone database management device which is capable of appropriately coping with a sudden situation change such as the interruption of power supply, thereby minimizing a data loss. Therefore, the database management device can manage data stably, so as to maximize reliability of data management.

Moreover, unlike existing databases that require installation and configuration by users, the present database management device is ready-to-use. Users can create tables and use the database using SQL (Structured Query Language) without installation and configuration of database software itself. Accordingly, this database management device is operable in a standalone and integral manner and is excellent in mobility. Furthermore, there is no necessity for modifying a high-cost management system, such as a main computer, to meet high-level specifications, thus curtailing installation costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An external standalone database management device comprising:
database means of an external standalone type, said database means including first storage means for semi-permanently storing a database, second storage means for temporarily storing said database, execution means for executing said database in real time, and initialization means for initializing said first and second storage means and said execution means with stable setup states when said database is executed; and
interface means installed in said database means for interfacing contents being executed in said database means with an external management system, said management system substantially managing said database;
whereby data, executed by said execution means and temporarily stored in said second storage means, is semi-permanently stored in said first storage means even though external power supply is interrupted.

2. The external standalone database management device as set forth in claim 1, further comprising voltage conversion means for converting a level of an external supply voltage into that of a drive voltage to said management device.

3. The external standalone database management device as set forth in claim 1, further comprising a state indicator for indicating operating states of said database means and interface means.

4. The external standalone database management device as set forth in claim 1, wherein said first storage means is at least one selected from a group consisting of a flash memory and a hard disk.

5. The external standalone database management device as set forth in claim 1, wherein said second storage means is at least one selected from a group consisting of a DRAM and an SDRAM.

6. The external standalone database management device as set forth in claim 1, wherein said execution means includes a microprocessor.

7. The external standalone database management device as set forth in claim 1, wherein said interface means is at least one selected from a group consisting of a USB port, a serial port, an IEEE1394 port, an IR port and a LAN port.
